(19) United States
(12) Patent Application Publication
(10) Pub. No.: US 2012/0191408 A1
(43) Pub. Date: Jul. 26, 2012

(54) SYSTEM AND METHOD FOR COUNTING AN ELEMENTARY MOVEMENT OF A PERSON

(75) Inventors: Christelle Godin, Grenoble (FR); Sébastien Dauve, Biviers (FR); François Favre Reguillon, Eybens (FR); Anthony Larue, Chaville (FR); Yanis Caritu, Saint Joseph De Riviere (FR); Sébastien Riccardi, Brezins (FR); Cyrille Soubeyrat, Reaumont (FR); Bruno Flament, Saint Julien De Ratz (FR); Aurélien Mayoue, Soisy Sur Seine (FR)

(73) Assignees: COMMISSARIAT A L'ENERGIE ATOMIQUE ET AUX ENERGIES, PARIS (FR); MOVEA, GRENOBLE (FR)

(21) Appl. No.: 13/387,608

(22) PCT Filed: Jul. 29, 2010
(86) PCT No.: PCT/EP10/60995

§ 371 Date: Apr. 12, 2012

(30) Foreign Application Priority Data
Jul. 29, 2009 (FR) 0955300

(51) Int. Cl. G06F 15/00

(52) U.S. Cl. 702/150

(57) ABSTRACT

System for counting an elementary displacement of a person, comprising a casing and fixing means for securely tying said casing to a part of the body of said person, comprising:
a magnetometer with at least one measurement axis; and
calculation means adapted for performing, for each measurement axis, the scalar product of at least one temporal mask and of the component of the signal along the measurement axis over the duration of said mask.

The invention pertains to a system and a method for counting an elementary displacement of a person, for example outward-return journeys or turnarounds of a swimmer in a pool, or outward-return journeys of a racing cyclist or runner in a given circuit.

An elementary displacement of a person can correspond to a change of direction or of heading of a person, or else to the traversal of a loop of a repetitive cyclic course such as a lap of a stadium by a runner or by a cyclist, or an outward-return journey of a swimmer in a pool. The signal to be detected must reflect an elementary displacement.

In an exemplary application, many runners desire to be able to accurately evaluate the distance that they have traversed during a racing session on foot or by bike on a stadium track, or over a course, a loop of which is repeated in a successive manner. In general, the loop performed is known to the party and corresponds for him to an informed distance. It is not always easy to perform his sports exercise while mentally counting the loops performed. The automatic counting of the loops performed thus makes it possible to obtain the total distance traversed. Likewise for a swimmer in a pool performing a series of lengths, the elementary displacement corresponds to a length followed by a turnaround, and then by a length in the reverse direction.

There exist systems making it possible to evaluate this type of distance traversed, for example as described in document U.S. Pat. No. 6,513,381 B2 pertaining to a foot movement analysis system, or in document FR 2912813A1 which pertains to a method for measuring the period, or the frequency, of the repetitive movement of an object in which at least one variable component of the projection of the terrestrial magnetic field onto the axis of a magnetometer tied to, or situated on, the moving object is measured, and the period, or the frequency, of the signal corresponding to the measurement is detected.

In another exemplary application, many swimmers wish to be able to accurately evaluate the distance that they have traversed during a swimming session. Having to count the number of lengths or of outward-return journeys traversed is irksome, comprises a non-negligible risk of error, and for a swimmer of good level, may disturb him and limit his performance.

There exist systems making it possible to automatically count the lengths swum, for example as described in American patent application US 2007/0293374A1, which pertains to a counter of pool outward-return journeys in a casing attached to the swimmer by fixing means comprising a compass sensor providing a signal which changes as a function of an outward direction or of a return direction of the swimmer in the pool. This counter of outward-return journeys for a swimmer, comprises a casing, means for fixing the casing on the swimmer, a compass sensor internal to the casing for providing an output signal which changes as a function of the outward or return direction of the swimmer in the pool, and a processor programmed to distinguish in the output signal of the compass sensor a change of direction of the swimmer and to count the number of outward-return journeys of the latter. This counter is also capable of counting the swimming movements of the swimmer using the counter.

Such a counter is of limited accuracy.

The aim of the present invention is to propose a system for counting an elementary displacement of a person, for example outward-return journeys of a swimmer in a pool, of improved accuracy at limited cost.

According to one embodiment of the invention, there is proposed a system for counting an elementary displacement of a person, comprising a casing and fixing means for securely tying said casing to a part of the body of said person. The system comprises:
a magnetometer with at least one measurement axis; and
calculation means adapted for performing, for at least one measurement axis, the scalar product of at least one temporal mask and of the component of the signal along the measurement axis over the duration of said mask.

It is thus possible, with improved accuracy, to count the occurrences of an elementary displacement of a person equipped with the system according to one aspect of the invention.

In one embodiment, the system comprises, furthermore, means for determining, for each measurement axis, said temporal mask, on the basis of the measurements provided by said magnetometer during said elementary displacement.

Thus the temporal mask may be determined by the user, on the basis of a recording of the measurements performed by the magnetometer, during an elementary displacement.

According to one embodiment, said elementary displacement is a loop of a cyclic displacement, such as a track lap, for example of a racing cyclist or runner.

Thus, the system can automatically inform the user of the number of laps that he has traversed during a session or indeed the distance traversed.

In one embodiment, for each measurement axis, said temporal mask is predetermined.

Thus, it is not necessary to calibrate the system by recording the signals corresponding to an elementary displacement.

For example, the system is adapted for detecting about-turns of a person, between two oppositely directed crossings of a straight line, in which, for each measurement axis, the mask comprises a first phase of a first duration T1 of a first constant value N, followed by a second phase of transition of a second duration T2 of zero value, followed by a third phase of first duration T1 of constant value −N equal to the opposite of the first constant value N, and of the component of the signal along the measurement axis over the duration 2T1+T2 of said mask.

Said first constant value N can equal 1, thereby limiting the number of calculations.

Said second duration T2 of the mask may be fixed and such that

$$T 1 + \frac{T 2}{2} < T min ,$$

Tmin representing a threshold time less than or equal to the minimum duration for performing a crossing of said straight line.

Thus, this mask causes spikes to appear at the moment of the changes of direction, during the calculation of the temporal scalar product, and the application of a norm to the scalar product. The transition phase T2 makes it possible to mask the signals corresponding to the transient phases of the changes of direction. In the case of swimming, the size of the mask is adapted so as to take account of the turnaround of a swimmer in a pool.

For example, said second duration T2 of the mask lies between 0 and Tmin/2.

In one embodiment, said second duration T2 of the mask is increasing as a function of time, and said calculation means are adapted for calculating a first norm of a vector whose components are said scalar products on each measurement axis taken into account and for detecting an about-turn when said first norm changes relative position with respect to a threshold.

Thus, a particular direction corresponding to the signal associated with the start of the mask is kept in memory.

For example, for a system adapted to swimming, detection is rendered more robust in the case where there are simply two types of possible displacements of the swimmer an outward journey and a return journey, without switching from ventral to dorsal.

According to one embodiment, when T2 is fixed, said calculation means are adapted for calculating a second norm of a vector whose components are said scalar products, and for detecting an about-turn of the person when said second norm exceeds a threshold.

This detection may be improved, by adding a condition of detection of local maximum of said second norm of the vector over a first sliding window.

It is thus possible to readily detect an about-turn of the person.

For example, said calculation means are adapted for:
creating said first sliding window upon detection of an exceeding of said threshold by said second norm;
determining the largest of the local maxima of said second norm over said sliding window and the instant associated with said largest local maximum, corresponding to a turnaround;
deactivating said first sliding window during a time span; and
reactivating said sliding window after said period when said second norm drops back below a threshold.

Thus, detection errors are greatly minimized, and detection is improved.

In an advantageous manner, the calculation means are adapted for detecting an about-turn of the person when the sign of said maximum component of said scalar product at the moment of the exceeding of said threshold by said second norm is different from the sign of this same component during the previous about-turn.

Indeed, this detection is further improved by the addition of a constraint on the sign of the maximum component of said scalar product. The maximum component at an instant t is the component which exhibits the maximum amplitude in absolute value at this instant. An about-turn of the person is thus detected when the sign of said maximum component at the moment of the exceeding of said threshold by said second norm is different from the sign of this same component during the preceding about-turn.

The use of such norms makes it possible to reduce the quantity of information to be processed, when at least two measurement axes are used, by going from two or three items of information to just one. The calculational load is thus limited.

According to one embodiment, said thresholds depend on the measurement range of the sensor to which the threshold is related, and/or a database of recordings of signals of the sensor or sensors for sequences of elementary displacements, and/or automatically.

In a preferential manner, said norms are replaced with a weighted sum of the absolute value of the scalar product components. The vector of the weighting weights is normed and allows for the energy distribution of said scalar products along the measurement axes. For each of these axes, the energy of said scalar product is calculated over a second sliding window whose size will be less than the minimum duration of realization of an elementary displacement.

Furthermore, the duration of said second sliding window depends on the minimum duration for performing a crossing of said straight line.

In one embodiment, said change of direction being an about-turn between two oppositely directed crossings of a straight line, said first duration T1 depends on the minimum duration for performing a crossing of said straight line. This minimum duration can also depend on the length of said straight line.

Thus, the disturbances due notably to swimming movements, to accelerations, and to magnetic disturbances are minimized without erasing the important event, namely the turnaround.

According to one embodiment, said calculation means are adapted for calculating said scalar product at a lower frequency than that of the measurements performed by said magnetometer.

The number of calculations performed is thus limited.

According to one embodiment, the system comprises, furthermore, an accelerometer, and said calculation means are adapted for calculating, for each measurement axis of said accelerometer, the standard deviation of the value measured on said measurement axis over a third sliding window.

The duration of the third sliding window lies between the time taken for an elementary movement (stride for racing, head movement for swimming) and the duration of the turnaround. For example for swimming this value will have to lie between 1 s and 5 s.

Thus, the reliability of the system is improved since the latter comprises a second indicator of the movements of the user.

For example, said calculation means are adapted for detecting a change of activity when, furthermore, at least one of said standard deviations changes value temporarily.

Indeed, if during a certain number of successive estimations, at least one of the calculated standard deviations changes value, then the person has changed activity, for example made an about-turn.

Thus, the system can better detect changes of activity, such as a change of the type of swimming, or an about-turn in the case of the system adapted to swimming.

In one embodiment, said calculation means are adapted for calculating a third norm of a vector of components said standard deviations on each measurement axis taken into account.

Thus, the calculational load is limited, since the number of items of information to be processed is limited.

For example, said calculation means are adapted for detecting a change of activity when the absolute value of the variation of said third norm exceeds a threshold and the absolute value of the variation of said third norm is a local maximum.

Thus, as a variant, a change of activity of the user, for example switch from the straight line to the about-turn, is also detected.

According to one embodiment, said calculation means are adapted for detecting an elementary displacement by comparing the detections of elementary displacement, which are performed in parallel, on the basis of a plurality of said masks.

It is thus possible to increase the effectiveness of detection by parallelizing diverse detection methods, and to effect a synthesis of the results.

According to one embodiment, the system is adapted for counting the outward-return journeys of a swimmer in a pool, in which said casing is leaktight and said elementary displacement is a pool length followed by a turnaround, followed by said length in the reverse direction.

The system is particularly appropriate for such a use. The number of lengths traversed is then the number of detected turnarounds, plus one.

Said first duration T1 can lie between 2 seconds and 10 seconds for a pool 25 meters in length, and lies between 2 seconds and 20 seconds for a pool 50 meters in length.

Thus, the swimming movements of a duration of about 1 s are erased, without eliminating the turnarounds (the world record for 50 m is of the order of 20 s).

Said second duration T2 of the first mask can lie between 0 and 5 seconds.

Thus, the duration of the turnaround between the two crossings of the pool in reverse directions is taken into account.

To have weighting coefficients representative of the distribution of the energy according to the three components, the choice of the duration of said second sliding window will be able to be prompted by that of said first duration T1.

For example, the duration of said second sliding window lies between 2 seconds and 10 seconds for a pool 25 meters in length, and lies between 2 seconds and 20 seconds for a pool 50 meters in length.

The duration of said third sliding window can lie between 1 and 5 seconds.

For example, said part of the body on which the system is disposed is the head.

Thus, the sensor may be integrated into the swimmer's goggles.

According to one embodiment, said thresholds depend on the measurement range of the sensor to which the threshold is related, and/or a database of recordings of signals of the sensor or sensors for swimming sequences, and/or automatically in the absence of a change of ventral/dorsal position of the swimmer during the swimming sequence.

The invention will be better understood on studying a few embodiments described by way of wholly non-limiting examples and illustrated by the appended drawings in which:

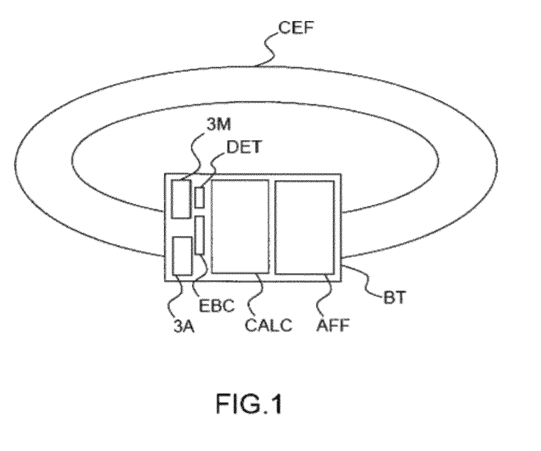

FIG. 1 schematically illustrates an embodiment of a system, according to one aspect of the invention;

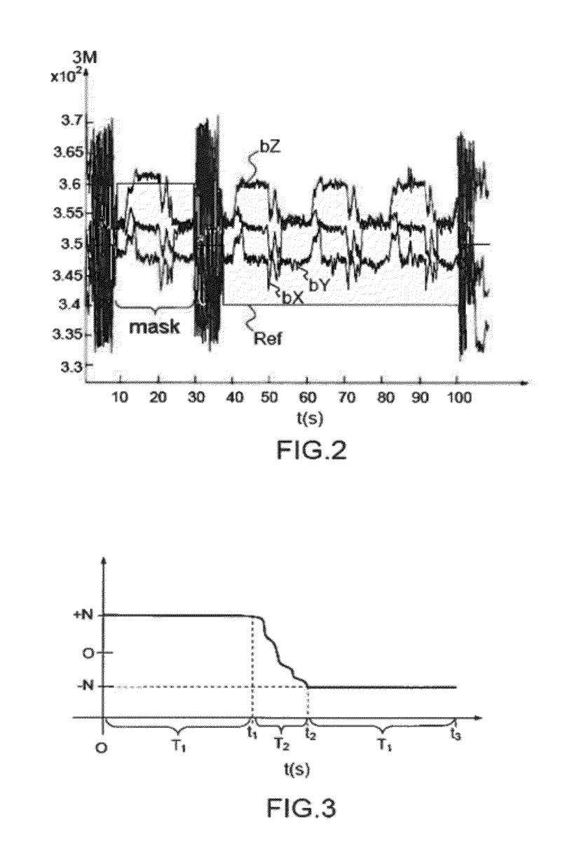

FIG. 2 represents an exemplary mask determined by recording a first lap of a building by bike;

FIG. 3 represents an exemplary predetermined mask; and

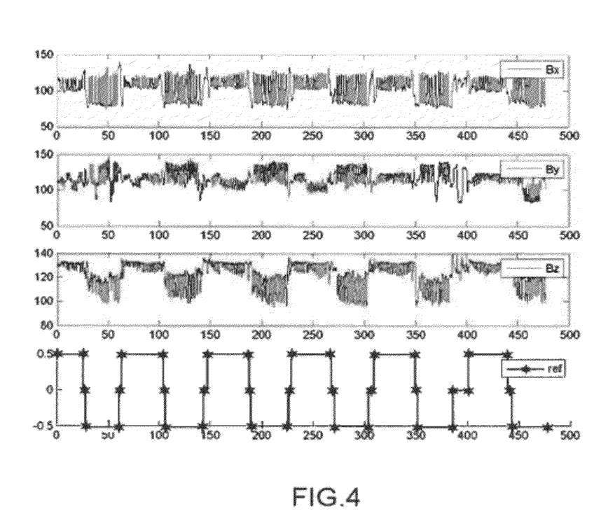

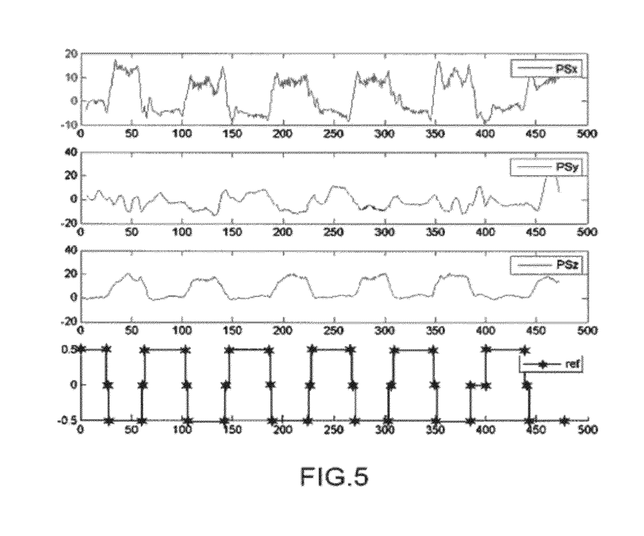

FIGS. 4 to 10 illustrate exemplary embodiments, according to one aspect of the invention, within the context of swimming. In all the figures, elements having the same references are similar.

Such as illustrated in FIG. 1, the system for counting an elementary displacement of a person comprises a casing BT comprising a magnetometer with at least one measurement axis, in this instance a triaxial magnetometer 3M. The casing BT is adapted for being fixed to a part of the body of said person, in this instance by means of an elastic fixing strap CEF. As a variant, any other fixing means may suit.

The casing BT comprises, furthermore an optional accelerometer with at least one measurement axis, in this instance a triaxial accelerometer 3A. A calculation module CALC performs, for each measurement axis of the triaxial magnetometer 3M, the scalar product of at least one mask and of the component of the signal along the measurement axis over the duration of said mask.

An optional determination module makes it possible to determine, for each measurement axis, a mask, on the basis of the measurements provided by the magnetometer 3M during an elementary displacement. A set of control buttons EBC can notably serve the user in determining the start and the end of the recording of the mask. As a variant, the mask may be predetermined.

Display means AFF, for example tied to the casing, can make it possible to display the results. As a variant, when the system is adapted to swimming and is fixed to the swimmer's goggles, the display may be replaced with a voice message in earphones.

The calculation module CALC is adapted for sampling the signals received from the sensors at a sampling frequency of greater than or equal to 0.5 Hz, while complying with Shannon's conditions.

FIG. 2 illustrates the recording of a mask corresponding to the recording of the signals transmitted by each measurement axis of the magnetometer 3M during a bike lap around a rectangular building, followed by the signals corresponding to three successive laps of the building by bike. The vibrations or jolts (with large variations of the signals of the magnetometer 3M) flanking the first lap corresponding to the mask make it possible to delimit the mask recording sequence (start and end). Vibrations also flank the recording sequence used for counting the bike laps (start and end of the sequence) so as to delimit it. The vibrations may be replaced with small jumps or a press of a push-button. There follow the detection of three successive laps, a second lap, a third lap and a fourth lap, by recognition of the mask.

FIG. 3 represents a predetermined mask applied for the calculation of scalar product for each axis, comprises a first phase of a first duration T1 of a first constant value N, between the instants 0 and t₁ followed by a second phase of transition of a second duration T2, from the instant t₁ to the instant t₂ of zero value, followed by a third phase of first duration T1 of constant value −N equal to the opposite of the first constant value N, between the instants t₂ and t₃. N may for example be equal to 1.

In the description which follows, by way of example, the system is adapted for counting the outward-return journeys of a swimmer in a pool, with a leaktight casing BT and in which the elementary displacement is a turnaround in a pool. Described notably is the way in which the calculation module operates.

The signal of the magnetometer 3M denoted B^{c}(tₖ)=B^{c}(kTe) (c being the index representing the measurement axis) is sampled in a regular manner with a sampling interval Te at the instants tₖ.

FIG. 4 illustrates an example of a system of the three raw signals transmitted by the three measurement axes of the magnetometer 3M, as well as a rectangular reference signal Ref indicating the switches from an outward to a return journey for crossing the pool.

Consider a vector M called a mask of dimension (2T1+T2)/Te and of duration 2T1+T2 and defined by:

M(i)=N for 0≦i<T1/Te

M(i)=0 for T1/Te≦i<(T1+T2)/Te

M(i)=−N for (T1+T2)/Te/Te ≦i<(2T1+T2)/Te

The scalar product on the axis c is defined by:

$${PS}^{c} ( {t}_{k} ) = {\sum }_{i = 0}^{( 2 T 1 + T 2 ) / Te - 1} M ( i ) {B}^{c} ( {t}_{k} - i )$$

The time T1 is chosen in such a way as to filter the periodic movements of the swimming, notably when the system is fixed to the swimmer's head. It must therefore be greater than two or three head movements.

For example, T1=8 s for a pool of length 25 m, the world record speed for crossing a 25 m pool being 10 s.

This value is increased for longer lengths so as to obtain better filtering.

The time T2 corresponds to a disregard phase, since the mask value is equal to zero during this period. This disregard makes it possible to ignore the transient periods during the turnaround whose movements are generally non-reproducible, notably from one individual to another or during a change of swimming.

In one embodiment, T2 may be variable, increasing by one sample at each time interval. A comparison is therefore always made with the value of the magnetic field at a reference instant taken at the start of the signal when the swimmer begins swimming. If the reference is chosen correctly, the stability of detection is improved. The scalar product has a notch shape with two values when there is no front-back switch. The calculation module CALC is then adapted for calculating a first norm of a vector whose components are said scalar products on each measurement axis taken into account and for detecting an about-turn when said first norm changes relative position with respect to a threshold.

In another embodiment, said second duration T2 of the mask may be fixed and such that

$$T 1 + \frac{T 2}{2} < T min ,$$

Tmin representing a threshold time. The second duration T2 of the mask lies, for example between 0 and Tmin/2.

To limit the cost of calculation, a scalar product on an axis of the magnetometer may be calculated every D samples. A calculation with a temporal spacing of a second is a priori sufficient for the case of swimming. For example, in the case of a sampling frequency of 100 Hz, it is possible to take D=100 (one point per second) for a 25 m pool.

This value may be increased for larger pools (or for slower swimmers) and decreased for smaller pools (or for faster swimmers). This makes it possible to have an equivalent number of samples per length whatever the duration of the length.

The calculation module can calculate, respectively for the cases T2 variable or T2 fixed, a first norm and a second norm of a vector whose components are the scalar products on each measurement axis taken into account.

The first norm and the second norm may each be, for example, defined by one of the following expressions:

$${( {\sum }_{c = 1}^{3} {α}^{c} \vert {PS}^{c} ( {t}_{k} ) \vert )}^{2} ; or \\ ( {\sum }_{c = 1}^{3} {α}^{c} \vert {PS}^{c} ( {t}_{k} ) \vert )$$

termed norm 1; or

$$( {\sum }_{c = 1}^{3} {{α}^{c} ( {PS}^{c} ( {t}_{k} ) )}^{2} )$$

termed norm 2.

### Where

$${\sum }_{c = 1}^{3} {α}^{c} \qquad c \{ 1 , 2 , 3 \}$$

The weighting coefficients α^{c} can also be defined so as to account for the distribution of the energy of the scalar product along the three measurement axes. In this case, the weighting coefficients for each component correspond to the energy of this component normalized by the total energy of the scalar product. The various energies are calculated over a second sliding window whose duration may be chosen equal to T1.

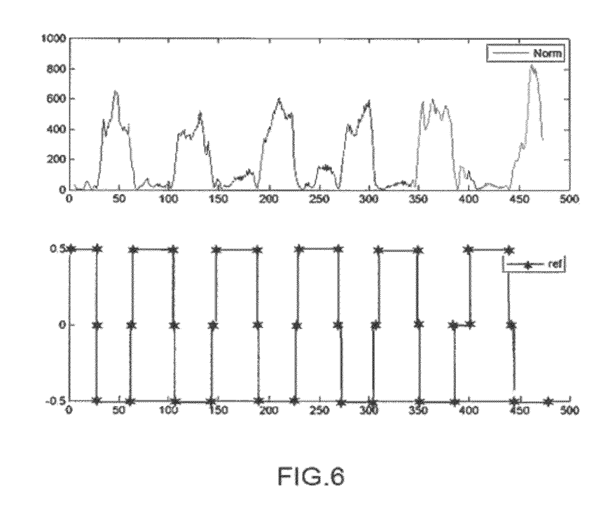

FIG. 5 illustrates an exemplary calculation of the three temporal scalar products, for T2 variable, in relation to the three measurement axes, corresponding to the measurement signals of FIG. 4.

In the case where T2 is variable, a turnaround of the swimmer can thus be detected when the first norm changes relative position, greater or lower, with respect to a threshold. Indeed, the calculation module CALC can determine transits either side of the threshold, both when the first norm is lower than the threshold, the swimmer crosses the pool in a first direction, and when the first norm is greater than the threshold, the swimmer crosses the pool in the other direction.

FIG. 6 illustrates an exemplary application of the norm 2 in the case of FIG. 5, with T2 variable. The threshold chosen in this instance equals about 250 (no unit is used as input to the system; integer values of a signal digitized by an analog/digital converter are available, thereby making it possible to avoid calibrating the sensors). Each transit either side of the threshold by the curve representative of the norm 2 corresponds to the detection of a turnaround, and the number of lengths traversed equals this number of turnarounds, plus 1. It is thus possible to also calculate the time taken to perform each length, between two successive turnarounds.

In the case where T2 is fixed, a turnaround of the swimmer can thus be detected when the second norm exceeds a threshold and, in an improved manner, when it is furthermore a local maximum over a sliding window.

The calculation module CALC can also be adapted for:
detecting an exceeding of a first threshold by the second norm;
creating a first sliding window upon detection of an exceeding of the threshold by the second norm;
determining the largest of the local maxima of the second norm over the sliding window and the instant associated with said largest local maximum, corresponding to a turnaround;
deactivating the first sliding window during a time span; and
reactivating the first sliding window after said period when the second norm drops back below a threshold, possibly being different or equal to the other threshold.

So as to reduce the number of false alarms, the calculation module CALC can also be adapted for including a constraint on the sign of the maximum component of the scalar product. Thus a turnaround of the swimmer will be detected solely in the case where the sign of the maximum component at the moment of the exceeding of the first threshold by the second norm is different from the sign of this same component during the preceding turnaround.

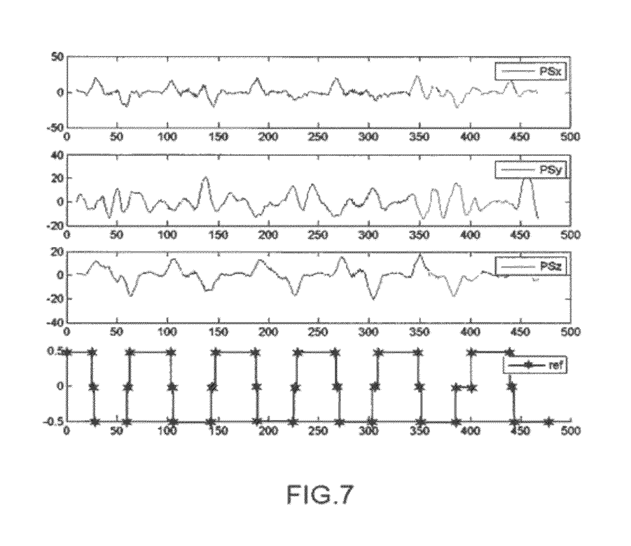

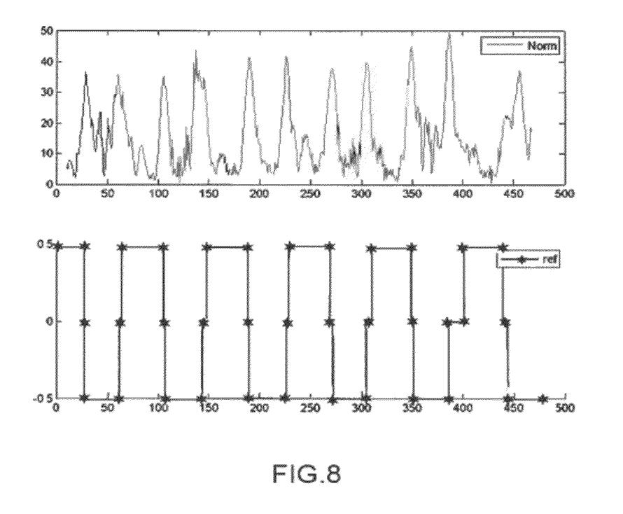

FIG. 7 illustrates, for signals according to FIG. 4, the calculation of the three temporal scalar products relating to the three measurement axes of the magnetometer 3M, for T2 fixed.

In FIG. 8 is illustrated the application of the norm 1 to the temporal scalar products of FIG. 7, for the case T2 fixed, in which the spikes represent a change of direction of crossing of the pool. The threshold chosen in this case equals about 30.

The choice of such thresholds must make it possible to detect the turnarounds. They may be determined in various ways:
a priori, as a function of the measurement range of the sensors
in an optimized manner with regard to a database of sensor signals during various swimming sequences taking into account the variability of the application: orientation of the pool, of the sensor on the swimmer's head, type of swimming, swimmer, geolocation. For these sequences the turnarounds are annotated manually. This optimization is done jointly with the other steps. The threshold allowing the best compromise between probability of detection and probability of false alarm is chosen.
automatically for each swimming sequence, if there is no ventral-dorsal change during the sequence. Indeed, in this case, the value of the notches (for T2 variable) and that of the spikes (for T2 fixed) is close to a constant for the whole of the sequence, since this value depends essentially on the orientation of the pool and the sensor. It is therefore possible to choose for example the maximum value of the first norm divided by 3 over the first 100 seconds. For T2 variable, it is also possible to take the mean value over the first 100 seconds.

When T2 is variable, as long as the number of points on the other side of the threshold does not exceed a predetermined number, for example a number of points corresponding to 10 s after decimation, the calculation module CALC reckons that the swimmer is still crossing the pool in the same direction and has not yet performed a turnaround. For example, if D=100, and if the sampling frequency Fe=100 Hz, this number of points is equal to 10.

When the system comprises an accelerometer, such as the accelerometer 3A, the calculation module CALC can calculate, for each measurement axis of said accelerometer, the standard deviation of the value measured on said measurement axis over a sliding window of a duration T. Thus, the calculation module CALC can detect an elementary displacement, in this instance a turnaround of the swimmer, upon a temporary change of value of one of said standard deviations.

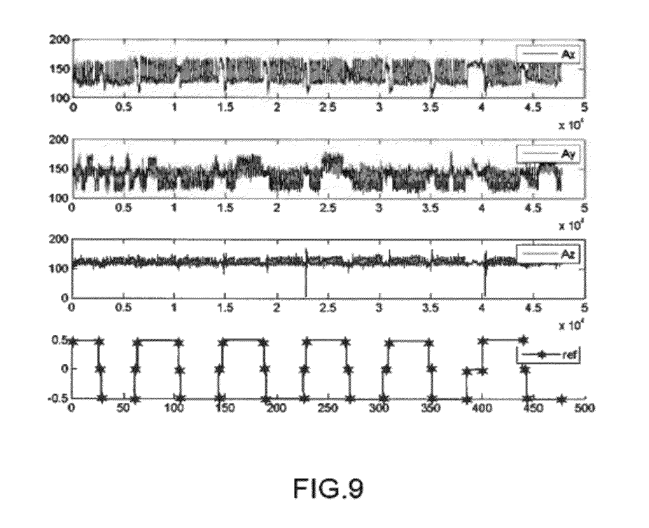

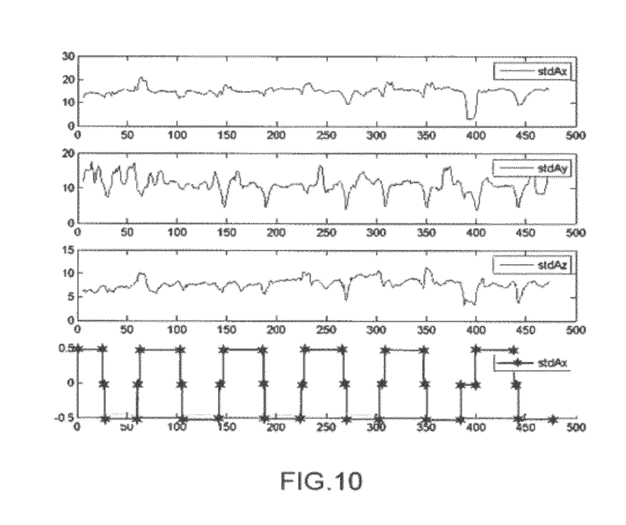

FIG. 9 illustrates an example of triaxial measurements transmitted by a triaxial accelerometer 3A for the same displacement as the signals transmitted by the triaxial magnetometer 3M in FIG. 4, and FIG. 10 represents the standard deviations calculated.

The calculation module CALC can calculate a third norm of a vector of components the standard deviations on each measurement axis taken into account.

The third norm may be, for example, defined by one of the expressions identical to those that were previously able to define the first and second norms.

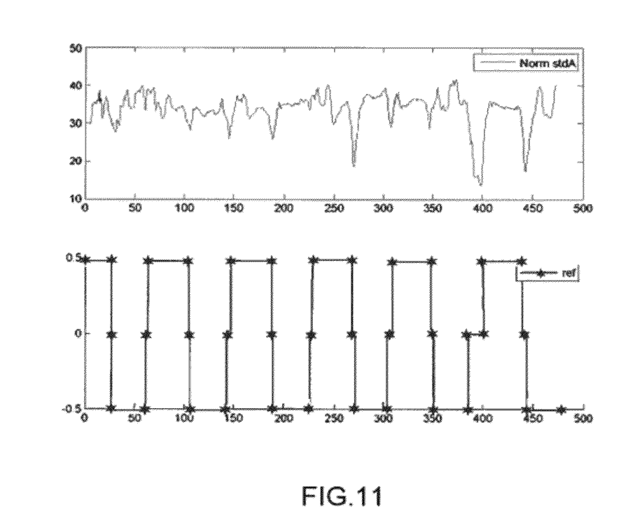

FIG. 11 illustrates the calculation of the third norm of a vector whose components are the standard deviations on each measurement axis.

Hence, the calculation module CALC can detect a change of activity when the absolute value of the variation of the third norm exceeds a threshold and the absolute value of the variation of the third norm is a local maximum.

The calculation module can also be adapted for detecting an elementary displacement by comparing the detections of elementary displacements performed in parallel on the basis of several masks.

This fusion principle is to choose a sliding window, also called a temporal neighborhood, on which it is possible to catalog the turnarounds detected by all the schemes. Thereafter, these items of information are fused to obtain a single instant with a numerical value. The selection strategies may be:
the instant of the turnaround having the largest value
the average of the instants
the median of the instants
the barycenter of the instants with the numerical values as weight.

After the choice of the instant of the turnaround after fusion, its value is determined if necessary for example by a sum of the values of the fused turnarounds. Another possible choice is to keep the largest value. This value is useful since it is possible to again undertake a thresholding of the potential turnarounds after fusion. By thresholding after fusion it is possible to improve the robustness of overall detection. This thresholding makes it possible to delete the turnarounds of low values which are predominantly false detections. It is even advisable to place thresholds that are not too high on each of the measurement pathways and therefore not to have much trouble with false alarms for each pathway, and thereafter another thresholding after fusion is performed to optimize.

1. A system for determining displacement of a person, comprising:
a casing and fixing means for coupling said casing to a part of the body of said person;
a magnetometer with at least one measurement axis; and
calculation means configured to perform, for at least one measurement axis, a scalar product of at least one temporal mask and of a component of a signal along the measurement axis over the duration of said temporal mask.

2. The system as claimed in claim 1, further comprising means for determining, for each measurement axis, said temporal mask, on the basis of measurements provided by said magnetometer during said displacement.

3. The system as claimed in claim 1, wherein for each measurement axis, said temporal mask is predetermined.

4. The system as claimed in claim 2, wherein said displacement is a loop of a cyclic displacement.

5. The system as claimed in claim 4, wherein said elementary displacement is a track lap.

6. The system as claimed in claim 3, wherein the system is configured to detect about-turns of a person, between two oppositely directed crossings of a straight line, wherein for each measurement axis, the mask comprises a first phase of a first duration T1 of a first constant value N, followed by a second phase of transition of a second duration T2 of zero value, followed by a third phase of first duration T1 of constant value −N equal to the opposite of the first constant value N, and of the component of the signal along the measurement axis over the duration 2T1+T2 of said mask.

7. The system as claimed in claim 6, wherein said first constant value N equals 1.

8. The system as claimed in claim 6, wherein said second duration T2 of said mask is fixed such that
$$T 1 + \frac{T 2}{2} < T min ,$$
Tmin representing a threshold time less than or equal to the minimum duration for performing a crossing of said straight line.

9. The system as claimed in claim 8, wherein said second duration T2 of said mask lies between 0 and Tmin/2.

10. The system as claimed in claim 6, wherein said second duration T2 of the mask increases as a function of time, and said calculation means is configured to calculate a first norm of a vector whose components are said scalar products on each measurement axis taken into account and for detecting an about-turn when said first norm changes a relative position with respect to a threshold.

11. The system as claimed in claim 6, wherein said calculation means is configured to calculate a second norm of a vector of components of said scalar products, and for detecting an about-turn of the person when said second norm exceeds a threshold.

12. The system as claimed in claim 11, wherein said calculation means is configured to detect an about-turn of the person when said second norm is a local maximum on a first sliding window.

13. The system as claimed in claim 12, wherein said calculation means is configured to:
create said first sliding window upon detection of exceeding said threshold by said second norm;
determining a largest of local maxima of said second norm over said sliding window and an instant associated with said largest local maxima, corresponding to a turnaround;
self-deactivating during a period; and
reactivating said first sliding window after said period when said second norm drops below a threshold.

14. The system as claimed in claim 11, wherein said calculation means is configured to detect an about-turn of the person when a sign of said maximum component of said scalar product at a moment of exceeding said threshold by said second norm is different from a sign of the same component during a previous about-turn.

15. The system as claimed in claim 10, wherein said threshold depends on a measurement range of a sensor to which the threshold is related, or a database of recordings of signals of a sensor for sequences of elementary displacements, or is determined automatically.

16. The system as claimed in claim 10, wherein said norms are replaced with a weighted sum of the absolute value of the scalar product components, weighting coefficients associated with each component being equal to an energy of the component divided by a total energy of the scalar product, the energies being defined on a second sliding window.

17. The system as claimed in claim 16, wherein a duration of said second sliding window depends on a minimum duration for performing a crossing of said straight line.

18. The system as claimed in claim 6, wherein said first duration T1 depends on the minimum duration for performing a crossing of said straight line.

19. The system as claimed in claim 1, wherein said calculation means is configured to calculate said scalar product at a lower frequency than that of the measurements performed by said magnetometer.

20. The system as claimed in claim 1, further comprising an accelerometer, wherein said calculation means is configured to calculate, for each measurement axis of said accelerometer, a standard deviation of a value measured on said measurement axis over a third sliding window.

21. The system as claimed in claim 20, wherein a duration of said third sliding window lies between a duration of an elementary movement and a duration of a turnaround.

22. The system as claimed in claim 20, wherein said calculation means is configured to detect a change of activity when, at least one of said standard deviations changes value.

23. The system as claimed in claim 20, wherein said calculation means is configured to calculate a third norm of a vector of components of said standard deviations on each measurement axis taken into account.

24. The system as claimed in claim 23, wherein said calculation means is configured to detect a change of activity when an absolute value of a variation of said third norm exceeds a threshold and the absolute value of the variation of said third norm is a local maximum.

25. The system as claimed in claim 1, wherein said calculation means is configured to detect displacement by comparing detections of displacement, which are performed in parallel, on the basis of a plurality of said masks.

26. The system as claimed in claim 1, wherein the system is configured to count outward-return journeys of a swimmer in a pool, in which said casing is waterproof and said displacement is a pool length followed by a turnaround, followed by said pool length in the reverse direction.

27. The system as claimed in claim 25, wherein said first duration T1 lies between 2 seconds and 10 seconds for a pool 25 meters in length, and lies between 2 seconds and 20 seconds for a pool 50 meters in length.

28. The system as claimed in claim 27, wherein said second duration T2 of the first mask lies between 0 and 5 seconds.

29. The system as claimed in claim 25, wherein the duration of said second sliding window lies between 2 seconds and 10 seconds for a pool 25 meters in length, and lies between 2 seconds and 20 seconds for a pool 50 meters in length.

30. The system as claimed in claim 24, wherein the duration of said third sliding window lies between 1 and 5 seconds.

31. The system as claimed in claim 24, wherein said part of the body is the head.

32. The system as claimed in claim 24, wherein said thresholds depend on a measurement range of a sensor to which the threshold is related, or a database of recordings of signals of a sensor for swimming sequences, or is determined automatically in the absence of a change of ventral/dorsal position of the swimmer during the swimming sequence.
